(19) United States
(12) Patent Application Publication
(10) Pub. No.: US 2026/0071048 A1
(43) Pub. Date: Mar. 12, 2026

(54) ELECTRODE COMPOSITE

(71) Applicant: FORD GLOBAL TECHNOLOGIES, LLC, Dearborn, MI (US)

(72) Inventors: Haibo ZHAO, Northville, MI (US); Zijie LU, Novi, MI (US); Wei XU, Livonia, MI (US)

(21) Appl. No.: 18/828,840

(22) Filed: Sep. 9, 2024

(51) Int. Cl. C08K 3/02; C08J 3/20; C08J 9/28; H01M 4/134; H01M 4/137; H01M 10/0525; H01M 10/0562

(52) U.S. Cl. CPC C08K 3/02; C08J 3/20; C08J 9/28; H01M 4/134; H01M 4/137; H01M 10/0525; H01M 10/0562; C08J 2333/20; C08K 2003/023; C08K 2201/001; C08K 2201/005

(57) ABSTRACT

A lithium-ion battery component with an electrode includes a current collector and a silicon-based active layer. The active layer includes a polyacrylonitrile lattice structure with continuous carbon domains. Silicon particles are distributed within the vacancies of the polyacrylonitrile lattice, which is configured to confine the silicon particles during the volume expansion and contraction that occurs during charge cycling.

### TECHNICAL FIELD

This disclosure relates to electrode materials for lithium-ion batteries.

### BACKGROUND

Silicon may be used as an anode material in batteries, including solid-state batteries, due to its high lithium storage capacity and low operating potential. Despite these benefits, silicon anodes face commercialization challenges, primarily due to the material's brittleness. The volume expansion that silicon undergoes during lithium-ion absorption induces mechanical stress, leading to pulverization. This repeated expansion and contraction during charge-discharge cycles may result in poor capacity retention and reduced cycle life. Pulverized silicon particles may disrupt the electrode-electrolyte interface and contribute to the formation of a solid-electrolyte interphase layer.

### SUMMARY

A lithium-ion battery component includes an electrode having a current collector, and a silicon-based active layer adhered thereon including a polyacrylonitrile lattice, with continuous carbon domains and silicon particles distributed within vacancies of the polyacrylonitrile lattice, configured to confine the silicon particles during volume expansion and contraction of the electrode during charge cycling. The silicon particles may be between 30 and 70 weight percent of the silicon-based active layer. The silicon particles may have a size ranging from 30 nanometers to 150 nanometers. The polyacrylonitrile lattice may have micropores ranging from 1 nanometer to 200 nanometers in size. The continuous carbon domains may have a mixture of cyclized carbon and graphitized carbon. The silicon-based active layer may have a capacity retention of at least 80% after 100 charge-discharge cycles.

A solid-state battery may include a current collector, a separator, and a pair of electrodes sandwiching the separator, at least one of the electrodes including a silicon-based active layer with silicon particles encapsulated and conductively interconnected by continuous carbon chains of a polyacrylonitrile composite that are configured to maintain conductive contact among the silicon particles during charge cycling of the electrode. The silicon particles may be between 30 and 70 weight percent of the silicon-based active layer. The silicon particles may have a size ranging from 30 nanometers to 150 nanometers. The polyacrylonitrile composite may have micropores ranging from 1 nanometer to 200 nanometers in size. The continuous carbon chains may be a mixture of cyclized carbon and graphitized carbon. The silicon-based active layer may have a capacity retention of at least 80% after 100 charge-discharge cycles. The polyacrylonitrile lattice may have a hierarchical porous structure including macropores, mesopores, and micropores. The polyacrylonitrile composite may have an electrical conductivity between 1 S/cm and 1000 S/cm. The continuous carbon domains may form a three-dimensional interconnected network throughout the polyacrylonitrile lattice.

A method of forming an electrode active material includes heating a precursor solution of a nitrile monomer and silicon nanoparticles to form a silicon-polymer gel of silicon nanoparticles distributed within a polymer matrix, lyophilizing the silicon-polymer gel to create a porous silicon-polymer structure, oxidizing the porous silicon-polymer structure to form an oxidized porous silicon-polymer structure, and carbonizing the oxidized porous silicon-polymer structure to form an electrode active material. The method may include controlling the carbonizing to produce an electrode active material wherein silicon nanoparticles comprise between 30 and 70 weight percent of the electrode active material. The silicon nanoparticles may have a size ranging from 30 nanometers to 150 nanometers. The porous silicon-polymer structure may include micropores ranging from 1 nanometer to 200 nanometers in size. The carbonizing step may be performed at a temperature between 300° C. and 1000° C. to produce continuous carbon domains comprising a mixture of cyclized carbon and graphitized carbon.

### BRIEF DESCRIPTION OF THE DRAWINGS

FIG. 1 is a schematic diagram of a negative electrode formation process;

FIG. 2 are images of microstructures in the negative electrode formation process of FIG. 1;

FIG. 3 is a schematic diagram of a battery cell;

FIG. 4 is a flowchart of a method to form an electrode;

FIG. 5 is a graph of voltage across capacity for a half cell containing the disclosed negative electrode material;

FIG. 6 is a graph of differential capacity across voltage for a half cell containing the disclosed negative electrode material;

FIG. 7 is a graph of cell internal resistance across cycles;

FIG. 8 is a graph of cycle performance;

FIG. 9 is a table of specific capacity and capacity retention percentage results for different tests;

FIG. 10 is a graph of capacity retention compared to rate; and

FIGS. 11-12 are Galvanostatic Charge-Discharge graphs of various charge rates.

### DETAILED DESCRIPTION

In accordance with this disclosure, detailed embodiments of electrode structures, manufacturing methods, and battery systems are disclosed herein. These embodiments are representative of an approach to increase lithium-ion battery performance. The figures and descriptions provided are illustrative and may not represent all possible variations or configurations. Certain features may be exaggerated or minimized to highlight particular aspects of the electrode assemblies and their formation processes. Thus, the specific structural and functional details disclosed are not intended to limit the scope of the invention, but rather to provide a foundational basis for those skilled in the art to implement various embodiments of the claimed subject matter.

Unless explicitly stated otherwise, all numerical values, measurements, percentages, weights, and similar quantitative parameters recited in the claims should be understood as being prefixed by the term “about.” This convention applies even when the term “about” is not explicitly used. The intent is to encompass variations arising from standard measurement techniques, manufacturing processes, material properties, and the inherent variability in the performance of the electrode structures and battery systems as defined by the claims. For instance, when a reference is made to a silicon particle size ranging from “30 nanometers to 150 nanometers” or a carbonization temperature range of “300° C. to 1000° C.,” such values should be interpreted as “about” the specified range, allowing for deviations that do not significantly alter the functionality or performance of the invention as claimed.

The disclosure addresses challenges in the development of high-performance lithium-ion and solid-state batteries by introducing a silicon-based composite material that increases the stability and efficiency of battery electrodes. The disclosed material utilizes a composite of silicon (Si) nanoparticles and a polyacrylonitrile (PAN)-derived carbon matrix, with a robust structure capable of mitigating silicon's volume expansion during charge cycling.

An Si-based active layer within an electrode is characterized by a PAN lattice with continuous carbon domains. These carbon domains are formed through the thermal treatment of PAN at temperatures ranging from 300° Celsius (C) to 1000° C., to form varying degrees of carbonization, from cyclized carbon to fully graphitized carbon, depending on the specific processing conditions. Si nanoparticles, sized between 30 and 150 nanometers (nm), are within the vacancies of the carbon lattice. This configuration effectively confines the silicon particles, minimizing their volumetric expansion and contraction during the electrochemical charging and discharging cycles. The confinement of the Si within the carbon matrix maintains the structural integrity of the electrode, which in turn increases the overall cycling stability of the battery.

In the context of lithium-ion battery applications, this Si-based active layer may be integrated with a current collector, where it provides high capacity due to the presence of Si, while simultaneously benefiting from the mechanical support and electronic conductivity provided by the carbon matrix. The Si content in the active layer may be adjusted to balance capacity with stability and may range from 30% to 70% by weight (wt. %). This control over the Si content and the nanoparticle size distribution achieves an effective balance between high energy density and long-term cycling performance.

For solid-state battery configurations, this disclosure utilizes the same Si-PAN composite. The continuous carbon domains within the composite act as conductive chains that interconnect the Si particles, maintaining that electrical conductivity throughout the electrode, even as the Si undergoes volumetric changes during charge cycling. This continuous connectivity is necessary for solid-state batteries, where maintaining consistent electrical contact is a challenge due to the solid electrolyte's different mechanical properties compared to liquid electrolytes.

The disclosed Si-PAN composite also incorporates a hierarchical porous structure, with pore sizes ranging from 1 to 200 nm. This porosity plays a role in accommodating the mechanical stresses associated with volume changes of the Si and facilitates ion transport within the electrode, thereby increasing the rate capability and overall electrochemical performance of the battery.

The synthesis of this electrode material involves the formation of a Si-polymer gel, followed by processing steps configured to create a desired porous structure and carbon domain configuration. Initially, Si nanoparticles are dispersed within a PAN solution to form a homogeneous gel. This gel undergoes thermal treatments to induce the formation of continuous carbon domains and the hierarchical porous structure, both of which contribute to the material's performance. The materials and methods are compatible with existing large-scale manufacturing processes, making them feasible for commercial production.

The Si-PAN composite increases cycling stability by effectively confining the Si particles within the carbon matrix, minimizing the effects of volume expansion in Si. The continuous carbon domains increase electronic conductivity within the electrode, reducing internal resistance and increasing overall cell performance. Additionally, the carbon coating surrounding the Si particles may mitigate the formation of the solid-electrolyte interface (SEI), an issue that may lead to capacity loss in conventional silicon anodes.

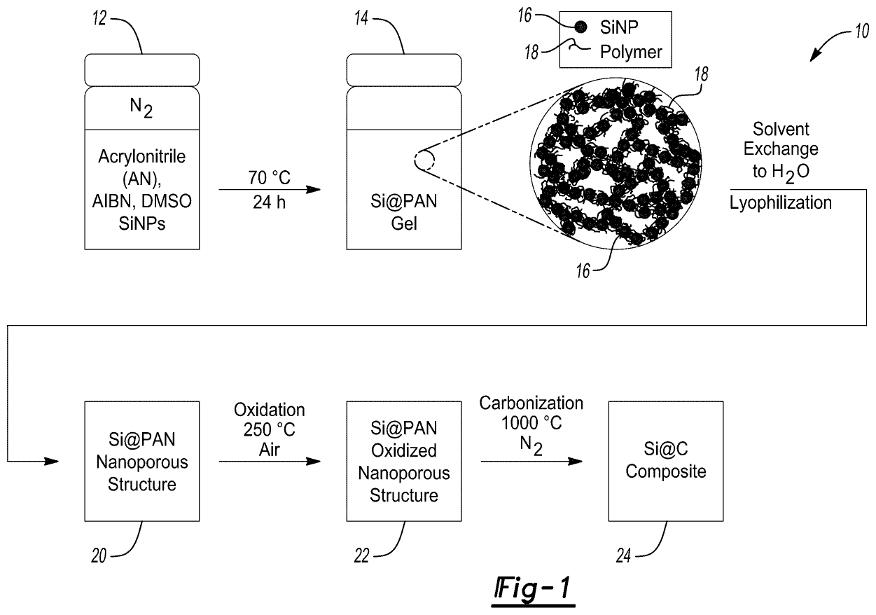

FIG. 1 shows a synthesis process 10 for Si-PAN composites. The flowchart shows a step-by-step procedure for creating the composite material. The process begins with an initial mixture 12 containing nitrogen gas, acrylonitrile, azobisisobutyronitrile, dimethyl sulfoxide, and Si nanoparticles. This mixture undergoes gel formation 14 by heating at 70° C. for 24 hours, resulting in the formation of a Si-PAN gel. A magnified circular inset shows the structure of this gel, with Si nanoparticles 16 distributed within a polymer matrix 18. The gel then goes through a solvent exchange and lyophilization step 20 where the original solvent is replaced with water, followed by lyophilization to create a Si-PAN nanoporous structure. Next, an oxidation process 22 occurs at 250° C. in air, transforming the material into a Si-PAN oxidized nanoporous structure. The final step carbonization 24, is conducted at 1000° C. under nitrogen gas, resulting in a Si-PAN composite.

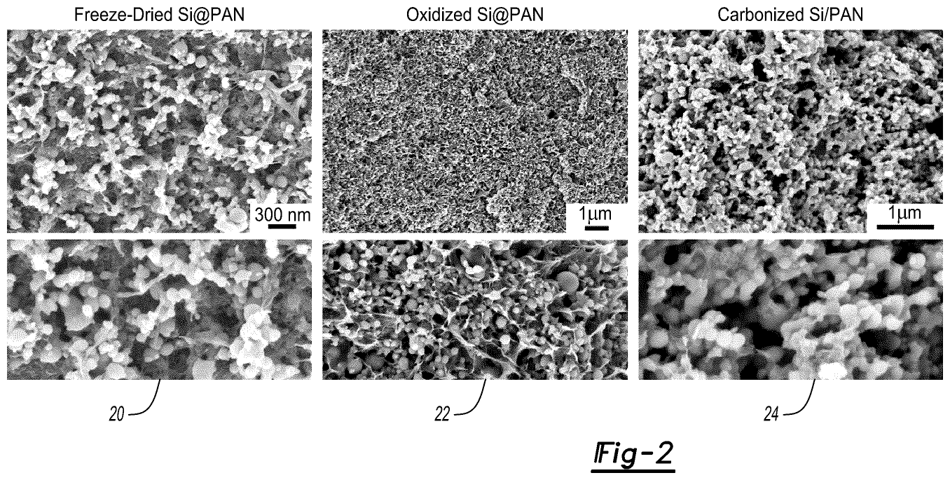

FIG. 2 shows a series of images of the microstructural evolution of the Si-PAN composite at stages of the synthesis process 10. Microstructure 20′ shows the material's morphology after solvent exchange and lyophilization, having a highly porous, low-density structure with the Si nanoparticles 16 distributed throughout the polymer network 18. Microstructure 22′ shows the changes following oxidation, where there is some shrinkage and darkening of the polymer network 18, with potential surface modifications of both the Si nanoparticles 16 and polymer network 18. Microstructure 24′ shows the composite after carbonization, exhibiting a denser, predominantly carbon-based framework with integrated Si nanoparticles 16. Microstructure 24′ shows signs of graphitization, with Si-carbide formation at interfaces, and altered porosity compared to microstructures 20′ and 22′.

FIG. 3 shows components of a battery cell 26 in a layered configuration, with each component stacked in a specific order to create a functional energy storage device. The battery cell 26 includes a positive current collector 28 which may be a stainless steel cap acting as a sealed enclosure for a positive terminal. Stacked with the current collector 28 is a stainless steel spring 30 that provides pressure to maintain contact between components and accommodate any volume changes during cycling. A stainless steel spacer 32 maintains proper spacing and electrical contact within the battery cell 26. A positive electrode 34 placed with the stainless steel spacer 32 may be composed of a cathode material suitable for solid-state lithium-ion batteries. A separator 36, which acts as a porous membrane that allows ion transfer while preventing direct contact between electrodes, is placed between the positive electrode 34 and negative electrode 38. The negative electrode 38 contains a Si-PAN composite active material formed by the synthesis process 10 and serves as an anode in the battery cell 26. A negative current collector 40 may be an aluminum-coated can that forms an outer casing of the battery cell 26.

In an experimental configuration, the battery cell 26 was constructed and tested under specific conditions. The negative electrode 38 was formed with lithium metal and a 7 wt. % Si-PAN composite with carbon as the active material, while the positive electrode 34 was graphite. Both electrodes 34 and 38 were formed with a loading weight of 5-6 milligram (mg) per centimeter squared (cm²) and a loading density of 1.5-1.6 grams (g) per cubic centimeter (cc). The battery cell 26 uses 1 mol per liter of lithium hexafluorophosphate in a mixture of ethylene carbonate and ethyl methyl carbonate in a 25/75 ratio by volume as an electrolyte. Testing was conducted at a full charge/discharge of 10 hours. The results showed the specific charge capacity of the battery cell 26, measured at the positive electrode 34, increased from 403.3 milliampere-hours (mAh) per g in the first cycle to 419.7 mAh/g by the third cycle, while the discharge capacity started higher at 454 mAh/g and stabilized around 425.9 mAh/g by the third cycle. Coulombic efficiency improved, from 88.84% in the first cycle to 98.54% by the third cycle, suggesting quick stabilization of initial irreversible processes. The cell operates between approximately 0 volts (V) and 2.5V vs. Li/Lit, with Galvanostatic Charge-Discharge (GCD) curves showing a plateau region around 0.2-0.1V during discharge, characteristic of lithium extraction from Si-based anodes. Cycling stability was demonstrated by similar GCD profiles for cycles 2 and 3, and overlapping charge curves for all three cycles. Some initial irreversible capacity loss was observed in the first cycle, but this decreased in subsequent cycles. Overall, the high specific capacity (over 400 mAh/g) exceeds that of conventional graphite anodes, and the rapid stabilization of coulombic efficiency suggests good reversibility of electrochemical processes.

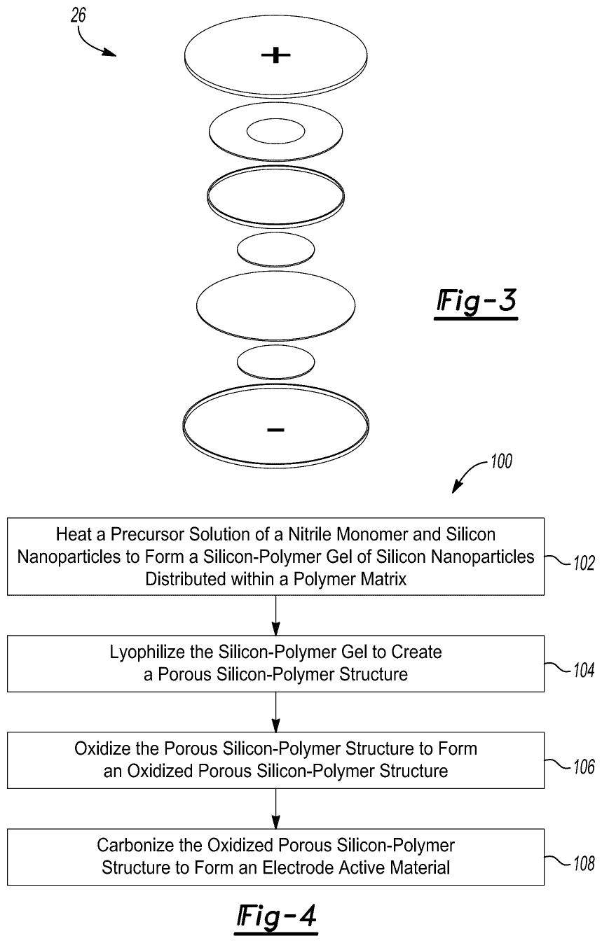

FIG. 4 is a flowchart of a method for forming an electrode active material 42. The process begins with step 44, where a precursor solution containing a nitrile monomer and silicon nanoparticles is heated to form a silicon-polymer gel. In this gel, silicon nanoparticles are distributed within a polymer matrix. The second step 46 involves lyophilizing the silicon-polymer gel produced in step 44. This lyophilization process creates a porous silicon-polymer structure, which influences the final material's performance characteristics. Following lyophilization, the third step 48 includes oxidizing the porous silicon-polymer structure formed in step 46. This oxidation process results in an oxidized porous silicon-polymer structure, further modifying the material's properties. The final step 50 includes carbonizing the oxidized porous silicon-polymer structure produced in step 48 into a final Si-PAN electrode active material.

The Si nanoparticles used in the initial precursor solution typically range from 30 to 150 nm in size. The porous structure created during lyophilization contains micropores ranging from 1 to 200 nm in size, which contributes to the material's electrochemical performance. The carbonization step 50 may be performed at temperatures between 300° C. and 1000° C. This temperature range allows for the formation of continuous carbon domains including a mixture of cyclized carbon and graphitized carbon. The resulting Si-PAN electrode active material contains Si nanoparticles that are between 30 and 70 wt. % of the total material.

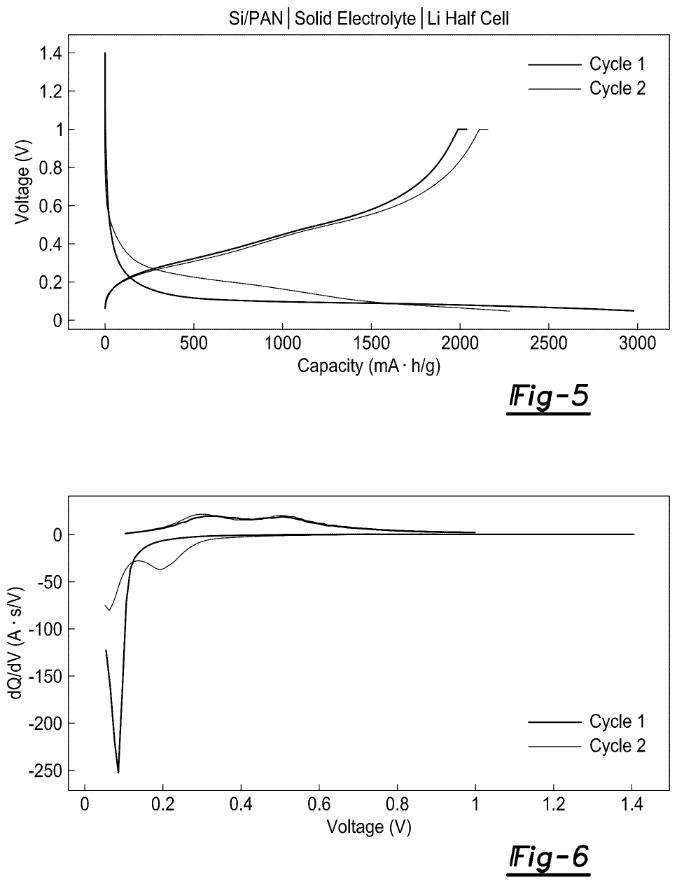

FIGS. 5-6 show electrochemical performance of a Si-PAN composite electrode material in a lithium half-cell configuration with a solid electrolyte. These tests were conducted using an anode composition of 66:28:2:4 by wt. % of Si-PAN:solid electrolyte:carbon black:binder, with an areal capacity of 3 mAh/cm². The voltage range was set at 0.05-1.0 V, and tests were performed at a temperature of 45° C. The Si-PAN composite used had a Si-to-carbon ratio of 55:45. FIG. 5 shows voltage profiles for two consecutive charge-discharge cycles, while FIG. 6 shows the corresponding differential capacity (dQ/dV) plots.

In FIG. 5, the voltage profiles show the high capacity of the Si/PAN composite, reaching approximately 2500-3000 mAh/g. This capacity significantly exceeds that of conventional graphite anodes (theoretical capacity ˜372 mAh/g) and approaches silicon's theoretical capacity of 4200 mAh/g. The charging curves exhibit a gradual increase in voltage with capacity, whereas the discharging curves display a more stable voltage plateau, characteristic of silicon-based anodes during lithiation and dilithiation processes. A notable difference between the first and second cycles, particularly in the low-capacity region of the discharge curve, suggests some initial irreversible capacity loss, which may be due to SEI formation.

FIG. 6 shows the electrochemical reactions occurring during cycling. Sharp peaks in the negative region (around 0.1V) during the first cycle indicate primary lithiation reactions of Si. These peaks become less pronounced in the second cycle, suggesting structural changes after initial lithiation. The broader peaks in the positive region (0.3-0.5V) represent the dilithiation process, with multiple peaks potentially indicating different stages of lithium extraction from the silicon structure. The differences between the first and second cycles are more pronounced in this differential capacity plot, particularly in the lithiation region, further corroborating the initial irreversible changes in the electrode.

The relatively stable performance over two cycles, especially in the higher voltage regions, suggests that the Si-PAN composite structure effectively mitigates issues associated with Si anodes, such as pulverization and capacity fade. This stability may be attributed to the microporous structure (1-200 nm pores) of the Si-PAN composite, which may help to accommodate the volume expansion of silicon domains during charging. Additionally, the continuous carbon domains resulting from PAN pyrolysis contribute to increased electronic conduction and lower internal resistance within the electrode, as shown by the smooth voltage profiles observed in FIG. 5.

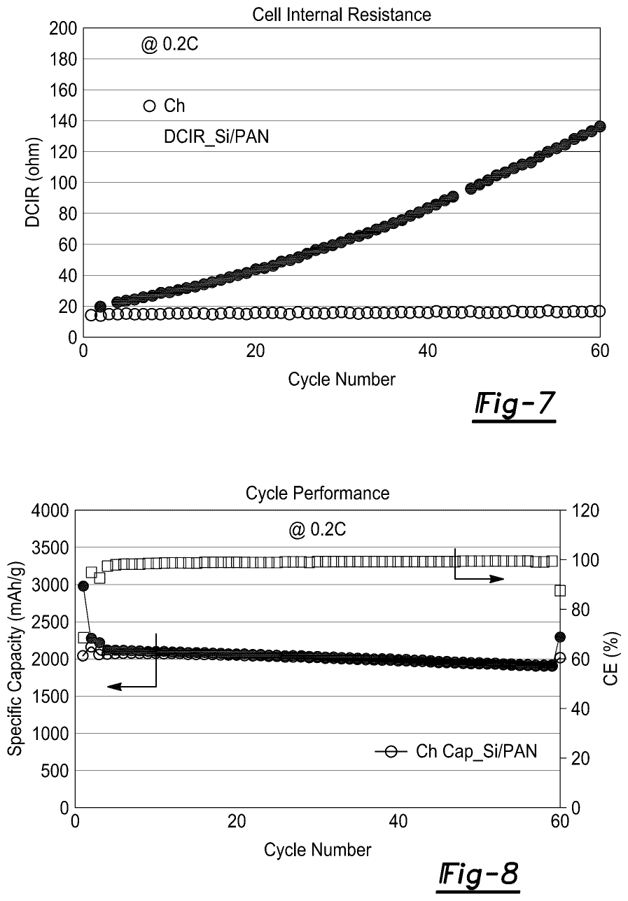

FIGS. 7-8 shows the performance characteristics of the Si-PAN composite anode material over 60 charge-discharge cycles at a 0.2 charge (C) rate. FIG. 7 illustrates the evolution of cell internal resistance comparing a standard anode material “Ch” and a Si-PAN composite “DCIR_Si/PAN”. The “Ch” series remains relatively constant around 20 ohms throughout the cycling, indicating stable resistance during charging. In contrast, the “DCIR_Si/PAN” series exhibits a gradual increase from approximately 20 ohms to 140 ohms over the 60 cycles, suggesting a progressive rise in the cell's internal resistance. This increase may be attributed to factors such as SEI layer growth or structural changes in the electrode during cycling.

FIG. 8 shows the cycling performance, plotting specific capacity and coulombic efficiency over the same 60 cycles. The Si-PAN anode exhibits an initially high specific capacity of around 3000 mAh/g, which quickly stabilizes at approximately 2000 mAh/g after the first few cycles. The discharge and charge capacities closely track each other, indicating reversibility of the lithiation/dilithiation processes. The anode material shows high capacity retention, with minimal fade observed over the 60 cycles. Coulombic efficiency rapidly reaches and maintains values close to 100%, further confirming the high reversibility of the electrochemical reactions. A slight uptick in capacity around cycle 60 is observed, which may be due to the activation of previously inactive material or measurement variability.

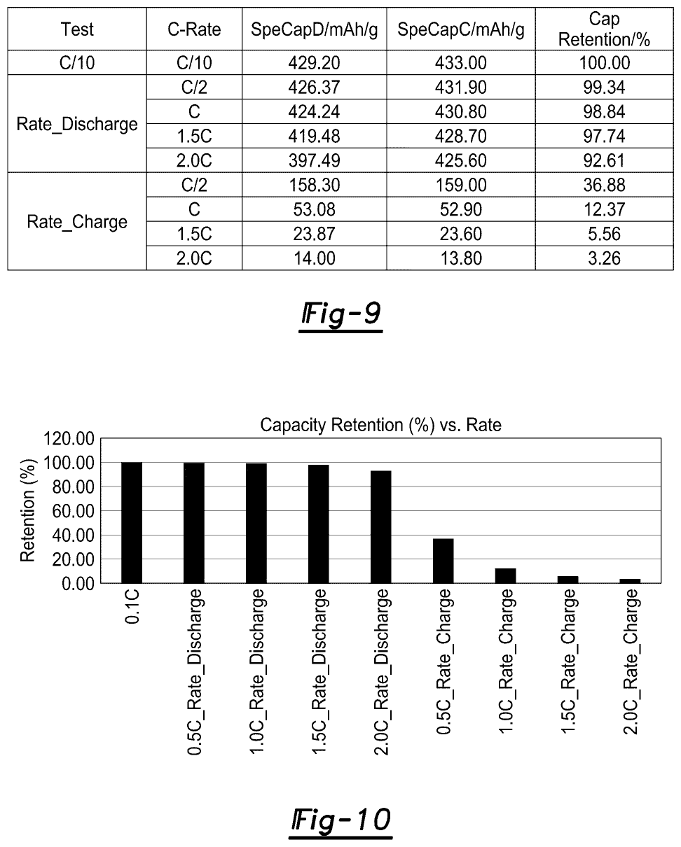

FIGS. 9 and 10 show the rate capability of the Si-PAN composite anode material, with specific capacity and capacity retention at various charge and discharge rates. FIG. 9 shows a tabular summary of the electrode's performance under different testing conditions. FIG. 9 includes charge over 10 hours (C/10) compared to discharge and charge at various C-rates. For each test condition, the C-Rate, specific discharge capacity (SpeCapD), specific charge capacity (SpeCapC), and capacity retention percentage are provided. The C/10 test shows the highest specific capacities of 429.20 mAh/g for discharge and 433.00 mAh/g for charge, serving as the baseline for 100% capacity retention. Discharge capacity changes with increasing C-rates from C/2 to 2.0 C. Even at 2.0 C, the electrode retains 92.61% of its capacity, this indicates high rate performance during discharge. Specific charge capacity rate is highly impacted by increasing C-rates. At C/2, the capacity retention drops to 36.88%, and at 2.0 C, it further decreases to just 3.26% of the baseline capacity.

FIG. 10 is a bar graph of the relationship between capacity retention and various charge/discharge rates. The graph shows capacity retention remains high (close to 100%) for discharge rates up to 2.0 C, with only a slight decrease as the discharge rate increases. However, there is a drop in capacity retention for charge rates, particularly as they increase from 0.5° C. to 2.0 C. The 0.5 C charge rate shows about 40% retention, which drops to approximately 15% for 1.0 C, and further decreases to below 10% for 1.5 C and 2.0 C charge rates. This graph suggests that the battery cell incorporating the Si-PAN composite performs well under various discharge rates.

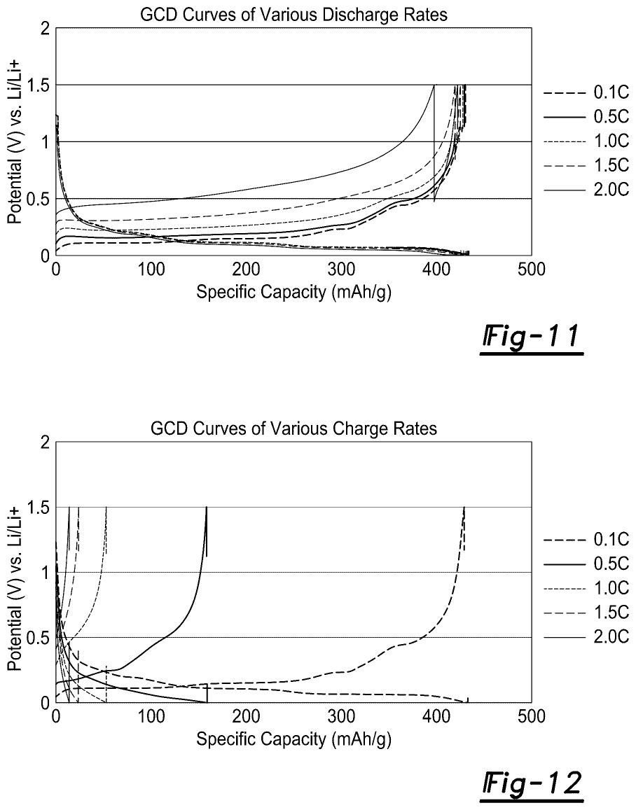

FIGS. 11 and 12 show GCD curves for the Si-PAN composite anode material at various rates. FIG. 10 shows the GCD curves for discharge rates ranging from 0.1 C to 2.0 C, with the x-axis representing specific capacity in mAh/g and the y-axis showing potential in volts versus Li/Lit. At the lowest rate (0.1 C), the discharge curve exhibits the highest specific capacity, reaching nearly 450 mAh/g. As the discharge rate increases, the curves shift towards lower specific capacities, with the 2.0 C rate showing the lowest capacity. All curves maintain a similar shape, featuring a steep initial drop followed by a more gradual slope, and ending with another steep drop. The potential plateau around 0.2-0.3V becomes less pronounced at higher rates, indicating increased polarization.

FIG. 12 shows GCD curves for charge rates also ranging from 0.1 C to 2.0 C. The 0.1 C charge curve reaches the highest specific capacity, similar to the discharge process. However, as the charge rate increases, there's a dramatic reduction in the achievable specific capacity. Higher rate curves (1.0 C to 2.0 C) show limited capacity, with steep potential increases. The 0.1 C and 0.5 C curves exhibit a more gradual slope and higher capacities compared to faster rates, with a visible potential plateau around 0.3-0.4V for lower rates that becomes less distinct at higher rates.

An analysis of Si content and pore characteristics in the composite material shows that as the Si content increases, there is a trend towards larger pore sizes, particularly in the mesopore range. This shift suggests that higher Si incorporation leads to the development of a more open porous structure. These structural changes with increasing Si content have implications for the material's performance as an anode in lithium-ion batteries. The higher Si content provides greater theoretical capacity, while the mesoporous structure can accommodate the volume changes associated with silicon's lithiation and dilithiation. However, the trade-off in surface area may affect the electrode-electrolyte interface and rate capability.

While the specific embodiments of the electrode structures, methods of forming such structures, and the resulting battery systems have been described in detail, these embodiments are not exhaustive of all potential configurations. The language used in this specification is intended for descriptive purposes and not as a limitation of the invention's scope. Modifications and variations may occur without departing from the core inventive concepts described herein. Additionally, the features and elements of various embodiments disclosed may be combined in novel ways to form additional embodiments within the scope of the claimed subject matter, even if such combinations are not explicitly detailed in this specification.

What is claimed is:

1. A lithium-ion battery component comprising:
an electrode having a current collector, and a silicon-based active layer adhered thereon including a polyacrylonitrile lattice, with continuous carbon domains and silicon particles distributed within vacancies of the polyacrylonitrile lattice, configured to confine the silicon particles during volume expansion and contraction of the electrode during charge cycling.

2. The lithium-ion battery component of claim 1, wherein the silicon particles are between 30 and 70 weight percent of the silicon-based active layer.

3. The lithium-ion battery component of claim 1 wherein the silicon particles have a size ranging from 30 nanometers to 150 nanometers.

4. The lithium-ion battery component of claim 1 wherein the polyacrylonitrile lattice has micropores ranging from 1 nanometer to 200 nanometers in size.

5. The lithium-ion battery component of claim 1 wherein the continuous carbon domains are a mixture of cyclized carbon and graphitized carbon.

6. The lithium-ion battery component of claim 1 wherein the silicon-based active layer has a capacity retention of at least 80% after 100 charge-discharge cycles.

7. A solid-state battery comprising:
a current collector;
a separator; and
a pair of electrodes sandwiching the separator, at least one of the electrodes including a silicon-based active layer with silicon particles encapsulated and conductively interconnected by continuous carbon chains of a polyacrylonitrile composite that are configured to maintain conductive contact among the silicon particles during charge cycling of the electrode.

8. The solid-state battery of claim 7 wherein the silicon particles are between 30 and 70 weight percent of the silicon-based active layer.

9. The solid-state battery of claim 7 wherein the silicon particles have a size ranging from 30 nanometers to 150 nanometers.

10. The solid-state battery of claim 7 wherein the polyacrylonitrile composite has micropores ranging from 1 nanometer to 200 nanometers in size.

11. The solid-state battery of claim 7 wherein the continuous carbon chains are a mixture of cyclized carbon and graphitized carbon.

12. The solid-state battery of claim 7 wherein the silicon-based active layer has a capacity retention of at least 80% after 100 charge-discharge cycles.

13. The solid-state battery of claim 7 wherein the polyacrylonitrile composite has a hierarchical porous structure comprising macropores, mesopores, and micropores.

14. The solid-state battery of claim 7 wherein the polyacrylonitrile composite has an electrical conductivity between 1 S/cm and 1000 S/cm.

15. The solid-state battery of claim 7 wherein the continuous carbon chains form a three-dimensional interconnected network throughout the polyacrylonitrile composite.

16. A method of forming an electrode active material comprising:
heating a precursor solution of a nitrile monomer and silicon nanoparticles to form a silicon-polymer gel of silicon nanoparticles distributed within a polymer matrix;
lyophilizing the silicon-polymer gel to create a porous silicon-polymer structure;
oxidizing the porous silicon-polymer structure to form an oxidized porous silicon-polymer structure; and
carbonizing the oxidized porous silicon-polymer structure to form the electrode active material.

17. The method of claim 16, further comprising controlling the carbonizing to produce the electrode active material wherein the silicon nanoparticles comprise between 30 and 70 weight percent of the electrode active material.

18. The method of claim 16 wherein the silicon nanoparticles have a size ranging from 30 nanometers to 150 nanometers.

19. The method of claim 16 wherein the porous silicon-polymer structure has micropores ranging from 1 nanometer to 200 nanometers in size.

20. The method of claim 16 wherein the carbonizing is performed at a temperature between 300° C. and 1000° C. to produce continuous carbon domains comprising a mixture of cyclized carbon and graphitized carbon.
